(19) United States
(12) Patent Application Publication
(10) Pub. No.: US 2013/0293172 A1
(43) Pub. Date: Nov. 7, 2013

(54) MOTOR WITH MAGNETIC SENSORS

(71) Applicant: SNTECH, INC., Phoenix, AZ (US)

(72) Inventor: YOUNG-CHUN JEUNG, Cypress, CA (US)

(21) Appl. No.: 13/937,064

(22) Filed: Jul. 8, 2013

Related U.S. Application Data
(63) Continuation of application No. 12/405,094, filed on Mar. 16, 2009, now abandoned.
(60) Provisional application No. 61/053,560, filed on May 15, 2008.

(51) Int. Cl. H02P 6/16; H02K 11/00

(52) U.S. Cl. CPC H02P 6/16; H02K 11/0021
USPC 318/400.38; 310/68 B

(57) ABSTRACT

Disclosed is an electric motor that includes a stator with a plurality of main poles, each of which includes a coil, and a rotor rotatable about an axis and having a magnet with magnetic poles in which N and S poles are alternating. The motor further includes a first sensor group of a plurality of magnetic sensors fixed relative to the stator, and a second sensor group of a plurality of magnetic sensors fixed relative to the stator. When operating the motor, the first sensor group can be selected so as to rotate the rotor in a first direction. The second sensor group can be selected so as to rotate the rotor in a second direction opposite to the first direction.

### CROSS-REFERENCE TO RELATED APPLICATION

This application a continuation application of U.S. patent application Ser. No. 12/405,094 filed Mar. 16, 2009, which claims the benefit of U.S. Provisional Application No. 61/053,560 filed May 15, 2008, the disclosures of which are incorporated herein by reference in its entirety.

### BACKGROUND

1. Field

The present disclosure is directed to an electric motor, and more particularly, to a method of operating an electric motor using rotor position detected by position detect sensors.

2. Discussion of the Related Technology

Two-phase brushless DC (BLDC) motors are used in a ventilation system to rotate fans installed in a ventilation duct of the ventilation system. The BLDC motor provides various advantages in its size, weight, controllability, low noise features and the like. One of the two-phase BLDC motors is disclosed in U.S. Application Publication 2006-0244333. The disclosed motor has a stator with electromagnetic poles wound with coils and a rotor with permanent magnetic poles. The stator and the rotor magnetically interact with each other, when electric current flows in the coils.

The foregoing discussion in the background section is to provide general background information, and does not constitute an admission of prior art.

### SUMMARY

One aspect provides a method of operating an electric motor. The method includes: providing an electric motor comprising a stator comprising a plurality of main poles, each of which includes a coil, a rotor rotatable about an axis and comprising a magnet, which includes a plurality of magnetic poles in which N and S poles are alternating, a first sensor group comprising a plurality of Hall effect sensors fixed relative to the stator, and a second sensor group comprising a plurality of Hall effect sensors fixed relative to the stator; selecting the first sensor group so as to detect a rotor position relative to the stator with the first sensor group; switching current flow of the coils based at least in part on the rotor position detected by the first sensor group so as to rotate the rotor in a first direction; selecting the second sensor group so as to detect a rotor position relative to the stator with the second sensor group; and switching the current flow of the coils based at least in part on the rotor position detected by the second sensor group so as to rotate the rotor in a second direction opposite to the first direction.

In the foregoing method, each sensor of the first and second sensor groups may be configured to detect magnetic poles of the rotor. Each sensor of the first sensor group may be configured to detect the change of magnetic poles when the rotor rotates in the first direction. The current flow of one of the coils may be synchronized with the change of the magnetic poles detected by one of the sensors of the first sensor group. Each sensor of the first sensor group may be configured to generate an alternating electric signal when the rotor rotates in the first direction. The current flow of one of the coils may be synchronized with the alternating electric signal of one of the sensors of the first sensor group. Each sensor of the second sensor group may be configured to detect the change of magnetic poles when the rotor rotates in the second direction.

Still in the foregoing method, the main poles may include a first phase pole with a first phase coil and a second phase pole with a second phase coil, wherein the first sensor group may include a first Hall effect sensor and a second Hall effect sensor, wherein the second sensor group may include a third Hall effect sensor and a fourth Hall effect sensor, wherein the first and third sensors are configured to be used in switching the first phase coil, and wherein the second and fourth sensors are configured to be used in switching the second phase coil. The first and second sensors may be configured to generate first and second alternating electric signals, respectively, when the rotor rotates in the first direction, wherein the current flow of the first phase coil may be synchronized with the first alternating electric signal and the current flow of the second phase coil may be synchronized with the second alternating electric signal when the rotor rotates in the first direction.

Yet in the foregoing method, the third and fourth sensors may be configured to generate third and fourth alternating electric signals, respectively, when the rotor rotates in the second direction, wherein the current flow of the first phase coil may be synchronized with the third alternating electric signal and the current flow of the second phase coil may be synchronized with the fourth alternating electric signal when the rotor rotates in the second direction. The main poles may further include a third phase pole with a third phase coil, wherein the first sensor group further includes a fifth sensor and the second sensor group further includes a sixth sensor, wherein the fifth and sixth sensors may be configured to be used in switching the third phase coil. The fifth sensor may be configured to generate a fifth alternating electric signal when the rotor rotates in the first direction, wherein the current flow of the third phase coil may be synchronized with the fifth alternating electric signal.

Further in the foregoing method, the first and second sensors may be configured to generate first and second alternating electric signals, respectively, when the rotor rotates in the first direction, wherein the first and second sensors may have a positional relationship with each other such that the first and second electric signals have a phase difference of about 90° from each other. The third and fourth sensors may be configured to generate third and fourth alternating electric signals, respectively, when the rotor rotates in the second direction, wherein the third and fourth sensors may have a positional relationship with each other such that the third and fourth electric signals have a phase difference of about 90° from each other.

The first and third sensors may have a positional relationship with each other such that, for a certain rotor position relative to the stator, the first sensor detects a magnetic pole of the rotor opposite to that detected by the third sensor. The first and third sensors may have a positional relationship with each other such that, for substantially entire positions of the rotor relative to the stator, the first sensor detects a magnetic pole of the rotor opposite to that detected by the third sensor. The first, second, third and fourth sensors may have their positional relationship with each other such that, for a first rotor position relative to the stator, the first and third sensors detect opposite magnetic poles of the rotor to each other and the second and fourth sensors are configured to detect opposite magnetic poles of the rotor to each other, and the first, second, third and fourth sensors may further have their positional relationship such that, for a second rotor position different from the first rotor position, the first and third sensors detect opposite magnetic poles of the rotor to each other while the second and fourth sensors detect the same magnetic pole of the rotor. The stator may include a plurality of auxiliary poles, each of which is positioned between two main poles.

Another aspect provides a method of operating an electric motor. The method includes: providing an electric motor comprising a stator comprising a plurality of main poles, each of which includes a coil, a rotor rotatable about an axis and comprising a magnet, which includes a plurality of magnetic poles in which N and S poles are alternating, a first sensor group comprising a plurality of magnetic sensors fixed relative to the stator, and a second sensor group comprising a plurality of magnetic sensors fixed relative to the stator; selecting the first sensor group so as to detect a rotor position relative to the stator; switching current flow of the coils based at least in part on the rotor position detected by the first sensor group so as to rotate the rotor in a first direction; selecting the second sensor group so as to detect a rotor position relative to the stator; and switching the current flow of the coils based at least in part on the rotor position detected by the second sensor group so as to rotate the rotor in a second direction opposite to the first direction.

A further aspect provides an electric motor comprising: a stator comprising a plurality of main poles, each of which includes a coil; a rotor rotatable about an axis and comprising a magnet, which includes a plurality of magnetic poles in which N and S poles are alternating; a first sensor group comprising a plurality of magnetic sensors fixed relative to the stator; a second sensor group comprising a plurality of magnetic effect sensors fixed relative to the stator; and an electric circuit configured to switch current flow of the coils based at least in part on the rotor's position detected by the first sensor group so as to rotate the rotor in a first direction and further configured to switch the current flow of the coils based at least in part on the rotor position detected by the second sensor group so as to rotate the rotor in a second direction opposite to the first direction.

### BRIEF DESCRIPTION OF THE DRAWINGS

FIG. 1A is a schematic view of a brushless DC motor having a stator and a rotor.

FIG. 1B is a sectional view taken along line 1B-1B shown in FIG. 1A.

FIG. 2A and 2B are schematic views of a brushless DC motor further having magnetic sensors according to one embodiment.

FIG. 3 is a block diagram of an electric circuit for operating a brushless DC motor based on signals from magnetic sensors.

FIG. 4 is a chart showing the relationship between signals transmitted from magnetic sensors and magnetic poles formed in each pole of a stator when a rotor rotates in the clockwise direction.

FIG. 5 is a chart showing the relationship between signals received from magnetic sensors and magnetic poles formed in each pole of a stator when a rotor rotates in the counter-clockwise direction.

FIG. 6 is a block diagram of an electric circuit for operating a motor based on signals transmitted from magnetic sensors.

### DETAILED DESCRIPTION OF EMBODIMENTS

Various embodiments will be described hereinafter with reference to the accompanying drawings.

### Structure of Motor

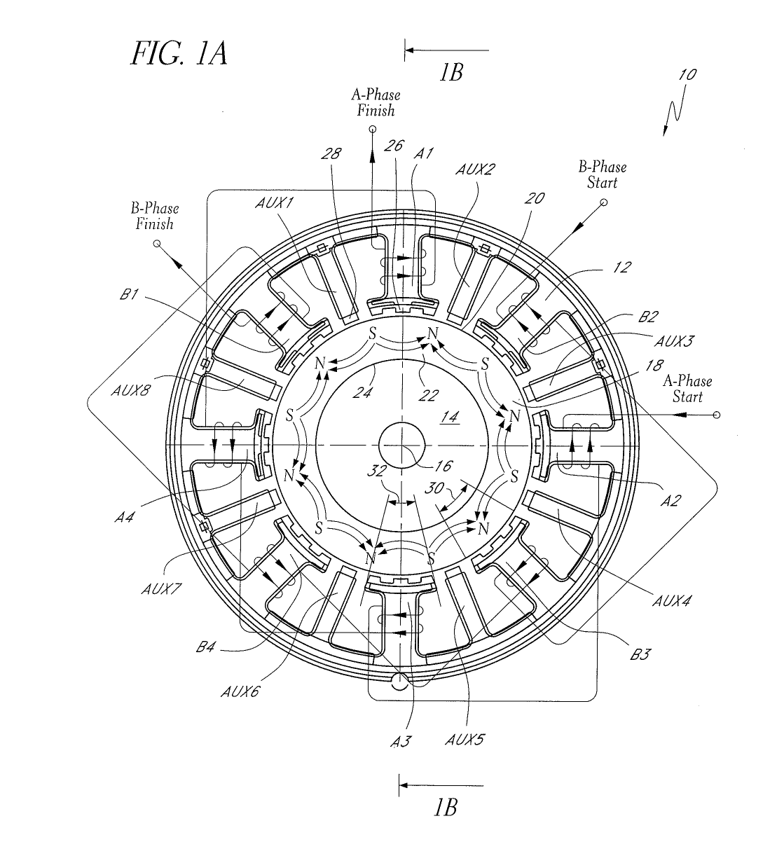

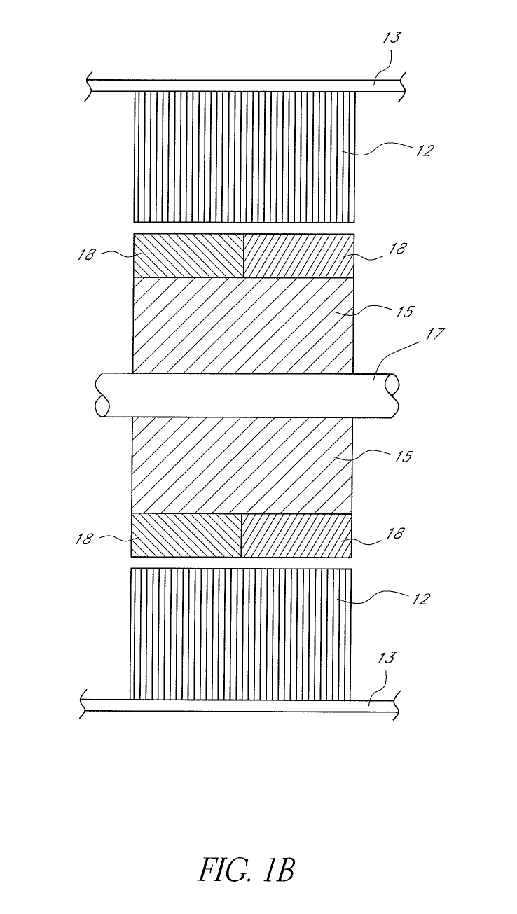

Referring to FIGS. 1A and 1B, in one embodiment, a brushless DC motor 10 has a stator 12 and a rotor 14 which is rotatable about an axis 16. The stator 12 is secured to the housing 13. The rotor 14 has a shaft 17, a plastic coupling ring 15 secured to the shaft, and ring-shaped magnets 18. Although FIG. 1B shows two magnets, the present subject matter is not limited thereto. Each magnet 18 is secured to the coupling ring 15, and has an outer surface 20 facing the stator 12. Each magnet 18 has a plurality of magnetic poles in which N (north) pole 22 and S (south) pole 24 are alternating. In one embodiment, the magnetic poles are formed substantially near the outer surface 20 of the magnet.

The stator 12 has a plurality of main poles A1, A2, A3, A4, B1, B2, B3 and B4 and a plurality of auxiliary poles AUX1 to AUX8. The main poles include A-phase poles A1 to A4 and B-phase poles B1 to B4. Each of the main poles has an end 26 facing the magnet 18. A-phase coils are wound on the A-phase poles A1 to A4. B-phase coils are wound on the B-phase poles B1 to B4. Each of auxiliary poles AUX1 to AUX8 is positioned between two main poles. Specifically, each of auxiliary poles AUX1 to AUX8 is interposed between the A-phase and B-phase poles.

In certain embodiments, the number of the main poles of the stator 12 is (4×n) and the number of the magnetic poles of the rotor magnet is (6×n), where n is an integer number greater than 0 (zero). In certain embodiments, the magnetic poles of the rotor magnet are arranged at the angular interval of approximately (360°+(6×n)). The angular width 30 of each magnetic pole of the rotor magnet can be up to approximately (360°+(6×n)). In some embodiments, the angular width 32 of the end 26 of each of the main poles A1 to A4 and B1 to B4 can be approximately (360°+(6×n)). Further, the A-phase poles are arranged at the angular interval of approximately (360°+(2×n)), the B-phase poles are arranged at the angular interval of approximately (360°+(2×n)), and the angular displacement between the immediately neighboring A-phase and B-phase poles is approximately (360°+(4×n)). In one embodiment, the angular width of the end 28 of each of the auxiliary poles AUX1 to AUX8 can be smaller than approximately (360°+(12×n)).

The motor shown in FIG. 1, the number of the main poles is 8 (eight) and the number of the magnetic poles is 12 (twelve), that is, n is 2 (two). In the illustrated embodiment of FIG. 1, the magnetic poles of the rotor magnet 18 are arranged at the angular interval of about 30°, and the angular width of each magnetic pole of the rotor magnet 18 can be about 30°. The angular width of the end 26 of each of the main poles A1 to A4 and B1 to B4 is about 30°. The A-phase poles are arranged at the angular interval of about 90°, the B-phase poles are arranged at the angular interval of about 90°, and the angular displacement between the immediately neighboring A-phase and B-phase poles is about 45°.

In an embodiment, a motor has 4 (four) main poles of the stator and 6 (six) magnetic poles of the magnet, that is, n is 1 (one). In the embodiment, the angular width of each magnetic pole is about 60°. The A-phase poles are arranged at the angular interval of about 180°, the B-phase poles are arranged at the angular interval of about 180°, and the angular displacement between the immediately neighboring A-phase and B-phase poles is about 90°.

### Magnetic Sensors

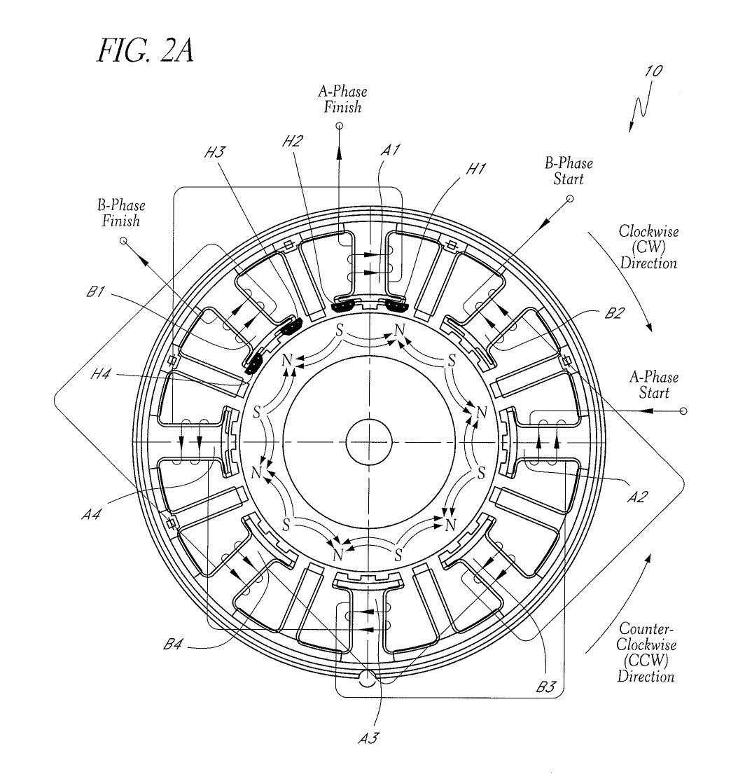

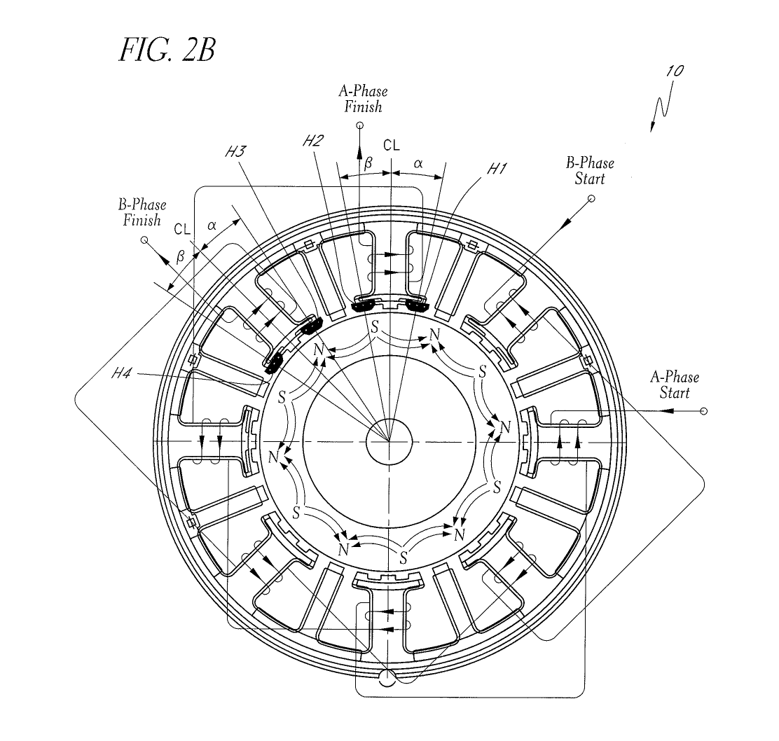

Referring to FIGS. 2A and 2B, the motor 10 has magnetic sensors, for example, Hall effect sensors, or coils. In certain embodiment, the motor 10 has a plurality of magnetic sensors H1 to H4. The magnetic sensors H1 to H4 are secured to a circuit board (not shown) at positions in a vicinity of the magnet 18, and are fixed relative to the stator 12.

The magnetic sensors includes a first sensor group of magnetic sensors H1 and H3, which is used for rotating the rotor 14 in the clockwise direction. The first sensor group includes the A-phase sensor H1 and the B-phase sensor H3. The plurality of magnetic sensors also includes a second sensor group of magnetic sensors H2 and H4, which is used for rotating the rotor 14 in the counter-clockwise direction. The second sensor group includes the A-phase sensor H2 and the B-phase sensor H4.

### Angular Positions of Magnetic Sensors

In one embodiment illustrated in FIGS. 2A and 2B, the magnetic sensors H1 and H2 for use in switching the current flow of A-phase coils are located in a vicinity of the A-phase pole A1. The magnetic sensor H1 is angularly spaced from the centerline CL of the pole A1 at an angle α, and the magnetic sensor H2 is angularly spaced from the centerline CL of the pole A1 at an angle β. In one embodiment, the angle α can be from about 10° to about 17°. In certain embodiments, the angle α can be about 10°, about 10.5°, about 11°, about 11.5°, about 12°, about 12.25°, about 12.5°, about 12.75°, about 13°, about 13.2°, about 13.4°, about 13.6°, about 13.8°, about 14°, about 14.2°, about 14.4°, about 14.6°, about 14.8°, about 15°, about 15.5°, about 16°, or about 17°. In some embodiments, the angle α can be an angle within a range defined by two of the foregoing angles. In another embodiment, the angle α can be equal to or smaller than about 15°, considering the delayed response of rotary components (for example, a shaft) connected to the rotor.

Similarly, in one embodiment, the angle β can be from about 10° to about 17.5°. In certain embodiments, the angle β can be about 10°, about 10.5°, about 11°, about 11.5°, about 12°, about 12.25°, about 12.5°, about 12.75°, about 13°, about 13.2°, about 13.4°, about 13.6°, about 13.8°, about 14°, about 14.2°, about 14.4°, about 14.6°, about 14.8°, about 15°, about 15.5°, about 16°, or about 17°. In one embodiment, the angle β can be an angle within a range defined by two of the foregoing angles. In another embodiment, the angle β can be equal to or smaller than about 15°.

Generally, in one embodiment of the motor having the rotor with (6×n) magnetic poles, the angle α can be from approximately (⅔)×(360°+(12×n)) to approximately ( 7/6)×(360°+(12×n)). In another embodiment of the motor having a rotor with (6×n) magnetic poles, the angle α can be equal to or smaller than approximately (360°+(12×n)), considering delayed response of rotary components (for example, a shaft) connected to the magnet.

### Motor Driver Circuit

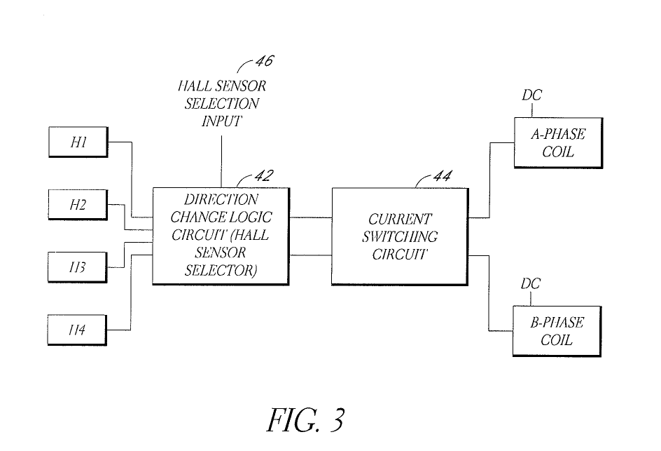

Referring to FIG. 3, the motor 10 is driven by a logic circuit 42 connected to the magnetic sensors H1 to H4, and a current switching circuit 44 that is connected to the logic circuit 42 and the A-phase and B-phase coils. The logic circuit 42 receives signals from the magnetic sensors H1 and H3 of the first sensor group and signals from magnetic sensors H2 and H4 of the second sensor group. Further, according to the magnetic sensors selection input 46, the logic circuit 42 select signals among signals transmitted from magnetic sensors H1 and H3 of the first sensor group and signals transmitted from magnetic sensors H2 and H4 of the second sensor group. The logic circuit 42 processes the selected signals and transmits the processed signals to the current switching circuit 44. Then, the current switching circuit 44 switches the A-phase and B-phase coils using the signals received from the logic circuit 42.

### Magnetic Sensors' Detection of Magnetic Poles and Switching of the Current Flow

Referring back to FIGS. 2A, 2B and 3, magnetic sensors H1 to H4 detect the magnetic poles of the magnet 18 of the rotor 14, and thus, detect the relative rotor position with respect to the stator 12. The magnetic sensors H1 to H4 generate electric signals of output voltage based on the position of the rotor 14. For example, the magnetic sensor H1 outputs a higher voltage level when it detects the N pole, while it outputs a lower voltage level when it detects the S pole. When the rotor 14 rotates, the N and S poles of the rotor are alternating. Thus, the magnetic sensor H1 generates an alternating electric signal and accordingly, it detects the change of the magnetic poles when the rotor 14 rotates.

The current switching circuit 44 switches the current flow of the A-phase and B-phase coils. In certain embodiments, the current switching circuit 44 synchronizes the change of the current flow of the coils with the change of the magnetic poles when the rotor rotates.

In some embodiments, the current switching circuit 44 switches the current flow of the coils based at least in part on the electronic signals transmitted from the magnetic sensors H1 and H3 of the first sensor group when the rotor 14 rotates in the clockwise direction. In one embodiment, the current switching circuit 44 synchronizes the change of the current flow of the coils with the alternating electric signal transmitted by the magnetic sensors H1 and H3 of the first sensor group. Similarly, the current switching circuit 44 switches the current flow of the coils based at least in part on the electronic signals transmitted from the magnetic sensors H2 and H4 of the second sensor group when the rotor 14 rotates in the counter-clockwise direction. In one embodiment, the current switching circuit 44 synchronizes the change of the current flow of the coils with the alternating electric signal transmitted in the magnetic sensors H2 and H4 of the second sensor group.

### Switching of Current Flow of Coils When the Rotor Rotates in the Clockwise Direction

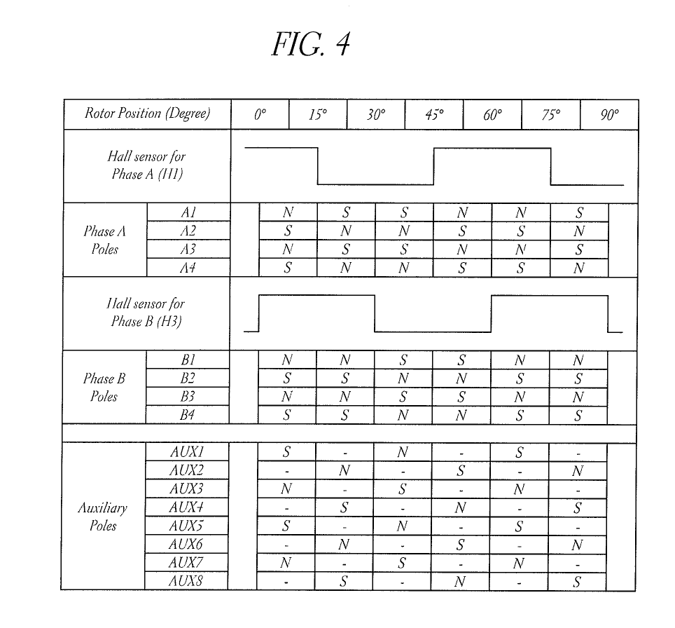

Referring to FIGS. 2A, 2B and 4, in some embodiments, when the rotor 14 rotates in the clockwise direction, the magnetic sensor H1 is used for switching the A-phase coils, and therefore, switching the magnetic poles of the A-phase poles A1 to A4. The magnetic sensor H3 is used for switching the B-phase coils, and therefore, switching the magnetic poles of the B-phase poles B1 to B4. FIG. 4 shows the relationship between the rotor position and magnetic poles of the stator poles when the rotor rotates in the clockwise direction.

In one embodiment shown in FIGS. 2A, 2B and 4, the angle α can be about 15°, and the angular displacement between the magnetic sensors H1 and H3 can be about 45°. For the sake of convenience of explanation, the rotor position relative to the stator 12 as illustrated in FIG. 2A is defined as 0°, and the rotor position relative to the stator 12 as illustrated in FIG. 2B is defined as 7.5°. In this embodiment, when the rotor 14 rotates in the clockwise direction, the magnetic sensor H1 for switching the A-phase coils detects the magnetic poles and then transmits the signals shown in FIG. 4. At the rotor position after the rotor's rotation in the clockwise direction of about 15°, about 45° and about 75°, the output voltage level of the magnetic sensor H1 changes, and the current flow of the A-phase coils is switched in synchronization with the change of the output voltage level of the magnetic sensor H1. And therefore, the magnetic poles of the A-phase main poles A1 to A4 are changed by the change of the current flow of the A-phase coils.

Similarly, when the rotor 14 rotates in the clockwise direction, the magnetic sensor H3 for switching the B-phase coils detects the magnetic poles and then transmits the signals shown in FIG. 4. At the rotor position after the rotor's rotation in the clockwise direction of about 0°, about 30°, about 60° and about 90°, the output voltage level of the magnetic sensor H3 changes, and the current flow of the B-phase coils is switched in synchronization with the change of the output voltage level of the magnetic sensor H3. And therefore, the magnetic poles of the B-phase main poles B1 to B4 are changed by the change of the current flow of the B-phase coil. In the illustrated embodiment, the electric signals of the magnetic sensors H1 and H3 are repeated at a period of about 60°.

In another embodiment shown in FIGS. 2A, 2B and 4, the angle α can be smaller than 15°, for example 14°. In this embodiment, at the rotor position after the rotor's rotation in the clockwise direction of about 14°, about 44° and about 74°, the output voltage level of the magnetic sensor H1 changes, and the current flow of the A-phase coils is switched in synchronization with the change of the output voltage level of the magnetic sensor H1. At the rotor position after the rotor's rotation of about 29°, about 59° and about 89°, the output voltage level of the magnetic sensor H3 changes, and the current flow of the B-phase coils is switched in synchronization with the change of the output voltage level of the magnetic sensor H3.

### Switching of Current Flow of Coils When the Rotor Rotates in the Counter-Clockwise Direction

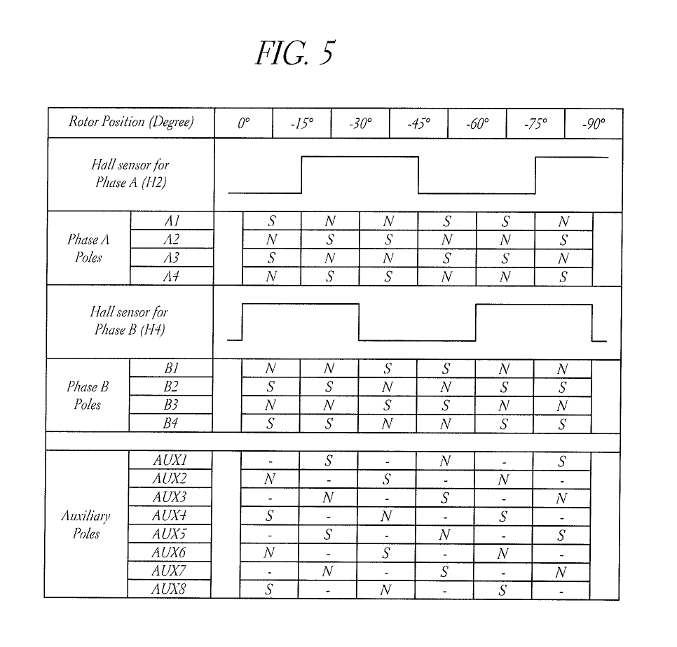

Similarly to the rotor's rotation in the clockwise direction, referring to FIGS. 2A, 2B and 5, in some embodiments, when the rotor 14 rotates in the counter-clockwise direction, the magnetic sensor H2 is used for switching the A-phase coils, and therefore, switching the magnetic poles of the A-phase poles A1 to A4. The magnetic sensor H4 is used for switching the B-phase coils, and therefore, switching the magnetic poles of the B-phase poles B1 to B4. FIG. 5 shows the relationship between the rotor position and magnetic poles of the stator poles when the rotor rotates in the counter clockwise direction.

In one embodiment shown in FIGS. 2A, 2B and 5, the angle β is about 15°, and the angular displacement between the magnetic sensors H2 and H4 is about 45°. For the sake of convenience of explanation, the rotor position relative to the stator 12 as illustrated in FIG. 2A is defined as 0°, and the rotor position relative to the stator 12 as illustrated in FIG. 2B is defined as −52.5°. In this embodiment, when the rotor 14 rotates in the counter-clockwise direction, the magnetic sensor H2 for switching the A-phase coils detects the magnetic poles and then transmits the signals shown in FIG. 5. At the rotor position after the rotor's rotation in the counter-clockwise direction of about −15°, about −45° and about −75° in the counter-clockwise direction, the output voltage level of the magnetic sensor H2 changes, and the current flow of the A-phase coils is switched in synchronization with the change of the output voltage level of the magnetic sensor H2. And therefore, the magnetic poles of the A-phase main poles A1 to A4 are changed by the change of the current flow of the A-phase coils.

Similarly, when the rotor 14 rotates in the counter-clockwise direction, the magnetic sensor H4 for switching the B-phase coils detects the magnetic poles, and then transmits the signals shown in FIG. 5. At the rotor position after rotation of about 0°, about −30°, about −60° and −90°, the output voltage level of the magnetic sensor H4 changes, and the current flow of the B-phase coils is switched in synchronization with the change of the output voltage level of the magnetic sensor H4. And therefore, the magnetic poles of the B-phase main poles B1 to B4 are changed by the change of the current flow of the B-phase coils. In the illustrated embodiment, the electric signals of the magnetic sensors H2 and H4 are repeated at a period of about 60°.

In another embodiment shown in FIGS. 2A, 2B and 5, the angle β can be smaller than 15°, for example 14°. In this embodiment, at the rotor position after the rotor's rotation in the counter-clockwise direction of about −14°, about −44° and about −74°, the output voltage level of the magnetic sensor H2 changes, and the current flow of the A-phase coils is switched in synchronization with the change of the output voltage level of the magnetic sensor H2. At the rotor position after the rotor's rotation of about −29°, about −59° and about −89°, the output voltage level of the magnetic sensor H4 changes, and the current flow of the B-phase coils is switched in synchronization with the change of the output voltage level of the magnetic sensor H4.

### Positional Relationship Between the Magnetic Sensors of Each Sensor Group

Referring to FIGS. 2A, 2B and 4, in certain embodiments, the A-phase sensor H1 of the first sensor group generates a first alternating electric signal and the B-phase sensor H3 of the first sensor group generates a second alternating electric signal when the rotor rotates in the clockwise direction. As shown in FIG. 4, the first and second electric signals have a phase difference of about 90° from each other. In the illustrated configuration, to generate electric signals that have a phase difference of about 90° from each other, the sensor H1 and H3 are arranged to have angular displacement between the magnetic sensors H1 and H3 of about 45°. In another embodiment, the angular displacement between the magnetic sensors H1 and H3 can be about 135°. In certain embodiments, the angular displacement between the magnetic sensors H1 and H3 can be approximately (360°+(4×n)), where n is an integer number. The foregoing angular positional relationship between the magnetic sensors H1 and H3 can be applied to the second sensor group of the magnetic sensors H2 and H4.

### Positional Relationship Between the Magnetic Sensors for the Same Phase Coils

Hereinafter, the positional relationship between the A-phase magnetic sensor H1 of the first sensor group and the A-phase magnetic sensor H2 of the second sensor group will be described. In certain embodiments, the magnetic sensors H1 and H2 have a positional relationship with each other such that, for a certain rotor position relative to the stator, the magnetic sensors H1 and H2 detect the different magnetic poles of the magnet 18 from each other.

For example, in the illustrated embodiment of FIG. 2A, the magnetic sensor H1 detects an N pole, and the magnetic sensor H2 detects an S pole. In this embodiment, at the rotor's position after the rotor's rotation in the clockwise direction of about 7.5° (which is equivalent to the rotor's position after the rotor's rotation in the counter-clockwise direction of about) −52.5° as shown in FIG. 2B, the magnetic sensor H1 still detects a N pole, and the magnetic sensor H2 still detects a S pole, and the magnetic sensors H3 and H4 detect N and S poles, respectively. At the rotor's position after the rotor's rotation in the clockwise direction of about 22.5° (which is equivalent to the rotor's position after the rotor's rotation in the counter-clockwise direction of about) −37.5°, the magnetic sensor H1 detects an S pole, and the magnetic sensor H2 detects an N pole. The magnetic sensors H3 and H4 detect N and S poles, respectively.

In certain embodiments where both of the angles α and β is about 15°, for substantially any rotor positions relative to the stator, the magnetic sensors H1 and H2 detect the different poles of the magnet 18.

In some embodiments where both the angles α and β are smaller than 15°, for example 14°, at the rotor's position illustrated in FIG. 2A, the magnetic sensors H3 and H4 detect the same pole, that is, N pole. However, the magnetic sensors H1 and H2 detect the different poles, that is, N and S poles, respectively. In other words, for substantially any rotor position relative to the stator, at least one pair among the first pair of the magnetic sensors H1 and H2 and the second pair of the magnetic sensors H3 and H4 detect different poles of the magnet 18.

### Electrical Circuit

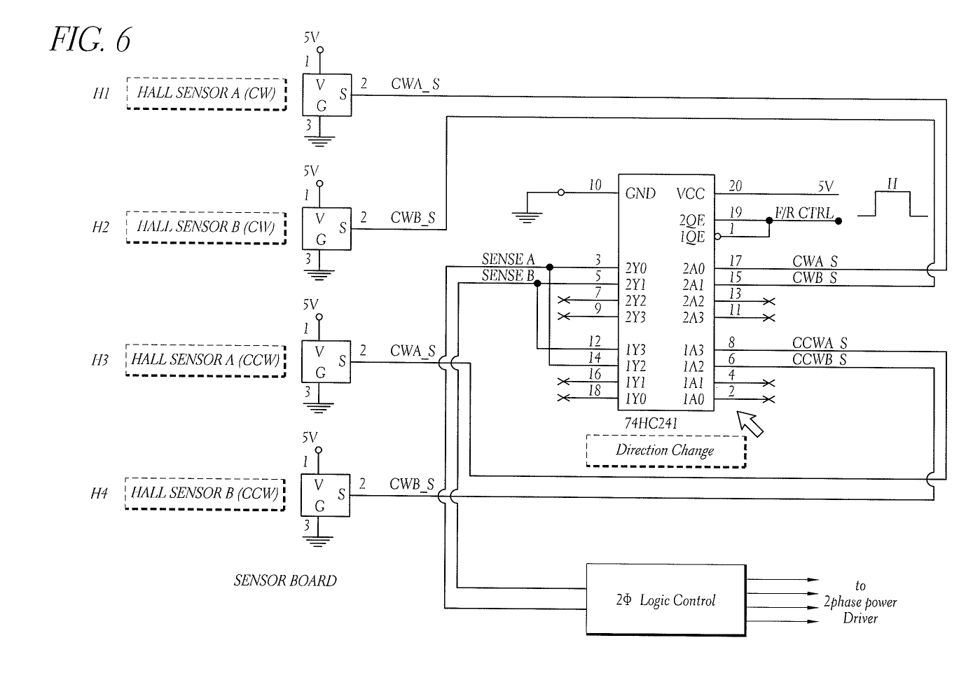

Referring to FIG. 6, in one embodiment, the motor driver circuit 50 has a direction selection logic device 52 and a switching control logic device 54 connected to the device 52. The magnetic sensors H1 to H4 are connected to the logic device 52. The device 54 is connected to the 2 (two) phase power driver circuit. The direction change signal or direction selection signal is input into the device 52. According to the direction selection input, the device 52 selects the magnetic sensors among the first sensor group of H1 and H3 and the second sensor group of H2 and H4, and transmits signals received from the selected sensor group or signals obtained after processing the sensor signals received from the selected sensor group.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method of operating a two-phase electric motor, the method comprising:
providing a two-phase electric motor comprising:
a stator comprising a plurality of main poles, which comprise a first phase pole with a first coil and a second phase pole with a second coil,
a rotor rotatable about an axis and comprising a rotor magnet, which comprises a plurality of magnetic poles in which N and S poles are alternating,
a first sensor group comprising first and second sensors, each of which is configured to monitor magnetic polarity of a portion of the rotor magnet passing by itself while the rotor rotates in a first direction, and
a second sensor group comprising third and fourth sensors, each of which is configured to monitor magnetic polarity of a portion of the rotor magnet passing by itself while the rotor rotates in a second direction opposite to the first direction;
detecting changes of magnetic polarity of the rotor magnet passing by the first sensor while the rotor rotates in the first direction;
detecting changes of magnetic polarity of the rotor magnet passing by the second sensor while the rotor rotates in the first direction;
detecting changes of magnetic polarity of the rotor magnet passing by the third sensor while the rotor rotates in the second direction;
detecting changes of magnetic polarity of the rotor magnet passing by the fourth sensor while the rotor rotates in the second direction;
controlling current flow in the first and second coils based at least in part on changes of magnetic polarity of the rotor magnet passing by the first, second, third and fourth sensors; and
wherein controlling comprises switching current flow directions in the first coil in synchronization with the changes of magnetic polarity passing by the first sensor while the rotor rotates in the first direction.

2. The method of claim 1, wherein each sensor of the first sensor group is configured to generate an alternating electric signal when the rotor rotates in the first direction.

3. The method of claim 1, wherein the first and second sensors are configured to generate first and second alternating electric signals, respectively, when the rotor rotates in the first direction, wherein the first and second sensors have a positional relationship with each other such that the first and second electric signals have a phase difference of about 90° from each other.

4. The method of claim 3, wherein the third and fourth sensors are configured to generate third and fourth alternating electric signals, respectively, when the rotor rotates in the second direction, wherein the third and fourth sensors have a positional relationship with each other such that the third and fourth electric signals have a phase difference of about 90° from each other.

5. The method of claim 1, wherein the first and third sensors have a positional relationship with each other such that, for a certain rotor position relative to the stator, the first sensor detects a magnetic pole of the rotor opposite to that detected by the third sensor.

6. The method of claim 1, wherein the first and third sensors have a positional relationship with each other such that, for substantially entire positions of the rotor relative to the stator, the first sensor detects a magnetic pole of the rotor opposite to that detected by the third sensor.

7. The method of claim 1, wherein the first, second, third and fourth sensors have their positional relationship with each other such that, for a first rotor position relative to the stator, the first and third sensors detect opposite magnetic poles of the rotor to each other and the second and fourth sensors are configured to detect opposite magnetic poles of the rotor to each other, and
wherein the first, second, third and fourth sensors further have their positional relationship such that, for a second rotor position different from the first rotor position, the first and third sensors detect opposite magnetic poles of the rotor to each other while the second and fourth sensors detect the same magnetic pole of the rotor.

8. The method of claim 1, wherein the stator comprises a plurality of auxiliary poles, each of which is positioned between two main poles.

9. The method of claim 1, wherein controlling comprises switching current flow directions in the second coil in synchronization with the changes of magnetic polarity passing by the second sensor while the rotor rotates in the first direction;
wherein controlling comprises switching current flow directions in the first coil in synchronization with the changes of magnetic polarity passing by the third sensor while the rotor rotates in the second direction; and
wherein controlling comprises switching current flow directions in the second coil in synchronization with the changes of magnetic polarity passing by the fourth sensor while the rotor rotates in the second direction.

10. The method of claim 9, wherein each of the first and second phase poles has an angular width, wherein an angular distance between the first sensor and third sensor is smaller than the angular width of the first phase pole, wherein an angular distance between the second sensor and fourth sensor is smaller than the angular width of the second phase pole.

11. A two-phase electric motor comprising:
a stator comprising a plurality of main poles, which comprises a first phase pole with a first coil and a second phase pole with a second coil;
a rotor rotatable about an axis and comprising a magnet, which comprises a plurality of magnetic poles in which N and S poles are alternating;
a first sensor group comprising first and second sensors, each of which is configured to monitor magnetic polarity of a portion of the rotor magnet passing by itself while the rotor rotates in a first direction;
a second sensor group comprising third and fourth sensors, each of which is configured to monitor magnetic polarity of a portion of the rotor magnet passing by itself while the rotor rotates in a second direction opposite to the first direction; and
one or more electric circuits configured to collectively:
detect changes of magnetic polarity of the rotor magnet passing by the first sensor while the rotor rotates in the first direction,
detect changes of magnetic polarity of the rotor magnet passing by the second sensor while the rotor rotates in the first direction,
detect changes of magnetic polarity of the rotor magnet passing by the third sensor while the rotor rotates in the second direction,
detect changes of magnetic polarity of the rotor magnet passing by the fourth sensor while the rotor rotates in the second direction,
control current flow in the first and second coils based at least in part on changes of magnetic polarity of the rotor magnet passing by the first, second, third and fourth sensors, and
wherein the electric circuit is further configured to switch current flow directions in the first coil in synchronization with the changes of magnetic polarity passing by the first sensor while the rotor rotates in the first direction.

12. The electric motor of claim 11, wherein the one or more electric circuits are further configured to switch current flow directions in the second coil in synchronization with the changes of magnetic polarity passing by the second sensor while the rotor rotates in the first direction;
wherein the one or more electric circuits are further configured to switch current flow directions in the first coil in synchronization with the changes of magnetic polarity passing by the third sensor while the rotor rotates in the second direction; and
wherein the one or more electric circuits are further configured to switch current flow directions in the second coil in synchronization with the changes of magnetic polarity passing by the fourth sensor while the rotor rotates in the second direction.

13. The electric motor of claim 12, wherein each of the first and second phase poles has an angular width, wherein an angular distance between the first sensor and third sensor is smaller than the angular width of the first phase pole, wherein an angular distance between the second sensor and fourth sensor is smaller than the angular width of the second phase pole.
